(19) United States
(12) Patent Application Publication
(10) Pub. No.: US 2017/0372013 A1
(43) Pub. Date: Dec. 28, 2017

(54) MEDICAL INFORMATICS DOCUMENTATION VIA HYPERMEDIA INTERFACE TERMINOLOGY SYSTEM

(71) Applicant: Christopher L. Wixon, Savannah, GA (US)

(72) Inventor: Christopher L. Wixon, Savannah, GA (US)

(21) Appl. No.: 15/634,678

(22) Filed: Jun. 27, 2017

Related U.S. Application Data
(60) Provisional application No. 62/355,499, filed on Jun. 28, 2016.

(51) Int. Cl. G06F 19/00; G06F 3/0482

(52) U.S. Cl. CPC G06F 19/322; G06F 19/3406; G06F 3/0482

(57) ABSTRACT

A hypermedia interface terminology system comprises a hypertext-based content generation system which utilizes semantic navigation of a knowledge repository for the purpose of transforming medical conceptions into human-readable and codified data forms.

### CROSS-REFERENCE TO RELATED APPLICATIONS

The present application claims priority to U.S. Provisional Application No. 62/355,499 entitled “EMBEDDED DATABASE MANAGEMENT SYSTEM WITH IMPROVED NAVIGATION AND SEARCH METHODS” and filed on Jun. 28, 2016, the contents of which are incorporated by reference herein in their entirety.

### FIELD

The present disclosure relates to electronic health records, and more particularly, to graphical user interfaces and database structures for creating and accessing electronic health records.

### BACKGROUND

The healthcare industry requires a method of information capture between patient and provider that occurs in a consistent, comprehensive, easy-to-use and reliable form. Recording of medical histories has traditionally been performed using lexical methods (typed, written, or dictated) due to the breadth and heterogeneous nature of healthcare domain. Lexical methods are based upon human language and provide nearly unlimited degrees of freedom of expression to describe complex medical concepts; however, outputted records are not computable in a standardized manner for the purpose of clinical research and aggregate decision support.

Standardizing healthcare documentation has been the impetus for legislative incentives for the adoption of Electronic Health Record (“EHR”) methodologies. However, the transition to electronic methodologies has been slow and has left medical providers feeling disenfranchised and dissatisfied. Key drivers of physician dissatisfaction are reduced productivity, poor user experience, and disruption of the doctor/patient interaction.

In order to communicate effectively, it is necessary to give labels to concepts. A shared collection of labels for the categories of interest forms a vocabulary or lexicon. Human beings often give multiple labels to each concept. This habit of giving multiple labels to the same category (synonymy), and the conversely, of giving the same label to different categories (homonymy, polysemy) leads to significant problems when trying to use the descriptions of objects in biological data resources.

Disambiguity of medical concepts is provided through standardized terminology systems which provide the intended meaning of a formal vocabulary used to describe conceptualization of objects of interest. In the healthcare industry, these are generally represented by a string of alphanumeric characters unique to a particular concept. These are stored in a pre-determined (aka pre-coordinated) format and not stored as natural language. It includes machine-interpretable definitions of basic concepts and descriptive logic operators which are asserted by the terminology schema. Terminology systems enable the interoperability of systems by allowing data to move seamlessly between systems.

In the healthcare domain, well-established Medical Reference Terminologies have explicitly codified nearly all medical conceptualizations. Commonly used terminologies include: the International Classification of Disease (ICD); the Current Procedural Terminology (CPT); Systematized Nomenclature of Medicine Clinical Terms (SNOMED CT); Logical Observation Identifiers Names and Codes (LOINC); and RxNorm.

Medical Reference Terminology systems play a key role in the healthcare systems. They are collaboratively maintained and extended by large teams of domain experts within the World Health Organization, American Medical Association, and the International Health Terminology Standards Organization. Best practice standards adhere to the 2017 Interoperability Standards Advisory (ISA) for utilization of “best available” terminology systems. One challenge facing the modernization of medicine is the development of data capture systems which are able to satisfy the dichotomous relationships between efficiency, expressivity, and data querability.

An important factor in software development is the translation of task specifications that define the functional capabilities of the software. Too often, the user's needs and limitations are not factored into the system. Consequently, no matter how well implemented other parts of the system may be, if the human/computer interface is intractable, the system will falter and ultimately fail. The end result will increase direct costs of wasted time and excessive errors, and indirect costs of time spent while learning the system.

Unfortunately, the sheer size of current Medical Reference Terminology systems creates utilization challenges as terminology systems are difficult to understand, browse, apply, and explain inferences. Existing medical terminology systems have adopted a very broad and shallow schema as a means to express the nuances of a complex healthcare domain. The format minimizes the number of choices a user is required to make; but necessarily, in order to meet the heterogeneity and breadth of the medical domain, each of the choices contains numerous possibilities.

While a broad (and shallow) format may be well-suited for applications which use lexical methods, the format is often distracting and inefficient for use in the human/computer interface. The International Classification of Disease, 10th edition (ICD10-CM), maintained by the World Health Organization, utilizes a 3-7 digit alphanumeric-code system. The first digit is alphabetic and represents a categorized body system. Under each category, there is the potential for 100 subcategories, represented numerically by the numbers [00-99]. By example, then, the term ‘I25’ is understood to represent the cardiovascular body system, and more specifically, a family of disease concepts involving atherosclerotic changes of the coronary arteries. The terminology assigns additional terms to further distinguish LATERALITY (right, left, bilateral, unknown), CHRONICITY (acute, subacute, chronic, unknown), OBJECTS OF VARIABLE PRECISION (e.g. gun: machine, hand, rifle), etc.

However, due to the vagaries of the medical domain, the terminology fails to adhere to a standard pattern. By example, ICD10-CM code T85.310A represents an initial encounter of an individual with breakdown of a right eye prosthesis. A similar diagnosis to the contralateral left eye prosthesis (T85.311A) is distinguished by the 6th digit, as represented by “0” or “1”.

However the pattern is not consistent through the terminology. Again, by example, the code for osteitis condensans of the RIGHT hand is pre-coordinated to the code M85.341, while the left hand is pre-coordinated to M85.342. While the 6th digit again represents laterality in this instance, the taxonomy uses “1” or “2” as a factor to distinguish laterality.

In still other cases, the terminology uses the 5th digit as a means to distinguish laterality. For example, chronic ear tympanitis of the right ear is coded as H73.11, while the left ear is represented by H73.12.

In some medical conditions, the terminology may not allocate any component of the code for laterality. Example: Clicking of the right or left hip is represented by the same code: R29.4.

While each term is understood to represent a distinct entity, which is well defined, and describe clinical entities to a high degree, proper selection of the most appropriate code often requires significant expertise of the coding agent (human or machine).

Due to the complexity, breadth, and inconsistency of current terminology systems, it is unreasonable to memorize and accurately recall the potentially thousands of codes used by a clinician, no matter how focused his/her medical expertise.

Medical computer record systems typically fail to offer methods which permit efficient access to established terminologies, and therefore only partial segments of the patient record are coded. Such art forms generally rely on post-data acquisition systems that encode only the diagnosis and procedure portions of the medical encounter. Even so, clinical coding is a time-consuming and highly skilled process.

Still, accurate and complete documentation of a medical ailment is of critical importance in epidemiology studies, prevention of patient harm, medico-legal documentation, and proper billing and reimbursement. Failure of current systems may present themselves in various ways: discordance between documentation and coding, omitting codes, wrong codes, etc. In turn, this may lead to incomplete and incorrect patient documentation as well as the loss of ability to analyze and report on this information. Lost time and money may result due to under-coding or rejected claims, and the captured information may be useless for meaningful communications with patients and other care providers.

Traditional database methodologies and the lack of an interconnected data model require non-contextual search methods and processing latency issues resulting in inefficiency, inaccuracy, and low provider satisfaction. The failure of current systems to efficiently transform complex medical thoughts into an electronic format fail to meet the performance demands of a medical domain that is extensive and complex and creates a real barrier to modernization of our health system. It is therefore highly desirable for the medical industry to possess a system which efficiently accesses structured terminologies in a highly accurate and complete manner, efficiently, and at the point of service.

### SUMMARY

Systems, methods, and computer program products (collectively “system”) are disclosed for creating structured electronic health care records. The system may provide a graphical user interface comprising a plurality of root elements; receive a selection of a first root element in the plurality of root elements; provide, in response to the selection of the first root element, a plurality of subsequent generation elements; receive a selection of a first subsequent generation element in the plurality of subsequent generation elements; determine that the first subsequent generation element is a terminal vertex; provide, based on the selection of the first subsequent generation element, a triplet interface corresponding to the first subsequent generation element; receive a selection of a triplet from the triplet interface; generate a human readable record comprising the triplet; generate a machine readable record comprising the triplet; and transmit the human readable record and the machine readable record to an electronic health record database.

In various embodiments, the system may transmit an API call to a clinical repository in response to the selection of the first root element. The clinical repository may comprise a human-edited repository of clinical concepts arranged in a multi-graph format. The triplet may comprise a diagnosis-attribute-concept expression. The triplet may comprise an affirmative state, a negative state, and a neutral state. The system may provide, in response to the selection of the triplet from the triplet interface, a plurality of subsequent triplet generation elements, and the system may receive a selection of subsequent triplet generation elements in the plurality of subsequent triplet generation elements. The first root element may comprise hypertext. The system may select the plurality of subsequent generation elements using forward chain inferencing.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject flatter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a hypermedia interface terminology system in accordance with various embodiments.

FIG. 2A illustrates a schematic diagram of a method for navigating a linear hierarchical data set in accordance with various embodiments.

FIG. 2B illustrates an example screenshot of a GUI for a provider interface corresponding to the linear hierarchical data set shown in FIG. 2A in accordance with various embodiments.

FIG. 3 illustrates an example screenshot of a graphical user interface on a user device in accordance with various embodiments.

FIG. 4 illustrates an example of a record which is provided in human readable text in accordance with various embodiments.

FIG. 5 illustrates an example of a screenshot of a record which is provided in machine readable code in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice principles of the present disclosure, it should be understood that other embodiments may be realized and that changes may be made without departing from the spirit and scope of the concepts disclosed herein. Thus, the detailed description herein is presented for purposes of illustration only and not of limitation. For example, the steps recited in any of the method or process descriptions may be executed in any order and are not necessarily limited to the order presented.

Systems, methods, and computer program products are disclosed which employ pre-acquisition data processing. The pre-acquisition system may minimize the negative impact to the user's freedom of expression, while maximizing efficiency and experience.

A medical encounter can be described by a series of well-understood, interrelated relationships:

PATIENT has some MEDICAL CONDITION; MEDICAL CONDITION is treated by some MEDICAL SERVICE; MEDICAL SERVICE is provided by a MEDICAL PRACTITIONER. Further characterization of the encounter may include the location of the visit (office, hospital, surgical center, etc.), the date of the service, or the like. These can easily be represented by a graph function.

According to various embodiments, a system/method is disclosed in which clinical concept metadata is organized into a schema which optimizes a content generation system. The system may utilize a meta-model, which is a model of a model. The meta-model provides the framework for a human-edited graph of accepted Health Informatics terms which codifies best practice patterns of attributes. The interconnected repository of medical ailments, procedures and metadata utilizes a graph schema. In various embodiments, the model may utilize a graph function that is generically known as a tree structure, or more specifically, a directed acyclic graph which has an IN degree of exactly one. The model may utilize a series of RDF graphs, each of which possess a unique RDF blank vertex as a parent. The blank vertex itself may not contain any data, but the blank vertex may serve as a parent vertex to a grouping of data. The blank vertex may perform multiple roles in an RDF graph. For example, the blank vertex may be the object in one graph statement, and the subject in a different graph statement. The different graph structures may be linked for the purpose of grouping metadata, with each terminal vertex in the hierarchy implying that it possesses only one edge, and that edge may be a directed edge coming into the vertex.

The model enables a rules-based, meta-templating system which semantically serves relevant metadata to the user using forward chain inferencing. Forward chain inferencing starts with the available data and uses inference rules to extract more data (from an end user, for example) until a goal is reached.

An MAIL editor may be used to build HTML files accessible by any web browser or device. In general, HTML files use hyperlinks to cross-link information. A hypertext document contains hyperlinks, which provides a user with both content and access to related data.

The development of a hypermedia application makes high utilization of the hyperlink as a means of enabling efficient interaction with large volumes of complex, nonlinear information and is generally delivered in the form of electronic pages.

As described herein, the hypermedia interface terminology system may bridge the gap between information that is in the clinical user's mind, i.e., the clinical intent, and information that can be interpreted by both humans and computer applications. In that regard, the hypermedia interface terminology system may facilitate the expression of clinical concepts in both a human and machine-interpretable format. Further, the hypermedia interface terminology system may help clinicians find the right diagnosis and procedure terms to document and code more comprehensively and accurately within their normal workflow.

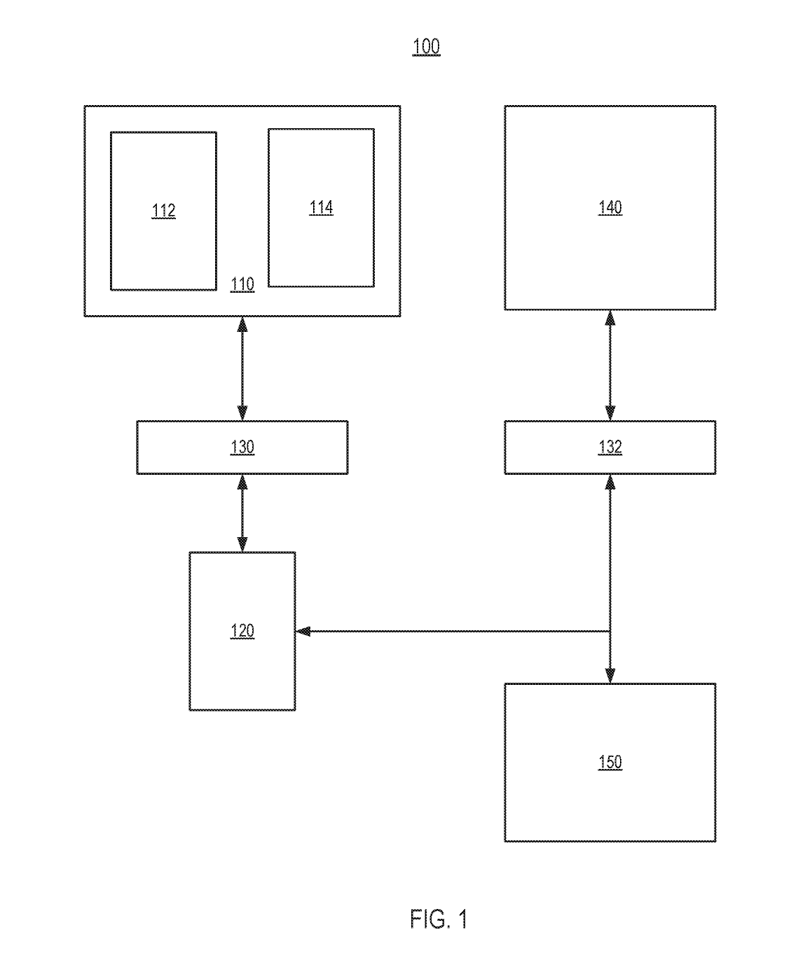

Referring to FIG. 1, a hypermedia interface terminology system 100 is illustrated according to various embodiments. The system 100 may comprise a clinical repository 110. The clinical repository 110 may comprise a human-edited repository of post-coordinated and pre-coordinated terms which conform to explicit terminology models within the healthcare domain. The data forms are constrained to the meta-model and utilize a directed acyclic graph in order to optimize the method of health informatics data capture. The directed acyclic graph may be a finite directed graph that consists of finitely many vertices and edges, with each edge directed from one vertex to another, such that there is no way to start at any vertex and follow a consistently directed sequence of edges that loops back to that vertex. The clinical repository 110 may utilize a Resource Descriptive Framework (“RDF”) graph to meet complex industry demands. The RDF graph is an infrastructure that enables the encoding, exchange and reuse of structured metadata. RDF is an application of XML that imposes structural constraints to provide unambiguous methods of expressing semantics. RDF may publish both human-readable and machine-processable vocabularies designed to encourage the reuse and extension of metadata semantics among disparate information communities. The structural constraints RDF imposes to support the consistent encoding and exchange of standardized metadata provides for the interchangeability of separate packages of metadata defined by different resource description communities. For more information on RDF, see “An Introduction to the Resource Description Framework,” D-Lib Magazine, May 1998, the contents of which are incorporated by reference in their entirety. The clinical repository 110 may integrate existing terminologies (CPT, SNOMED CT, ICD-10, LOINC, RxNorm, or other suitable terminology), for the purpose of better accessibility and consumability of healthcare information.

The clinical repository 110 may be a server-oriented knowledge base that functions as the concept index of the system and is comprised of a scripting language, such as PHP: Hypertext Preprocessor (“PHP”), and terminology data arranged in a fully-attributed multi-graph. Data elements contain a set of specifications, rules and processes that dictate how data is stored, accessed and presented by components of the system. Database design adheres to the 2016 Interoperability Standards Advisory (ISA) for “best available” characteristics. The clinical repository 110 may function as both content server and knowledge base, enabling the highest level of clinical documentation improvement (CDI) support available.

The clinical repository 110 may comprise two independent labeled hierarchical trees 112, 114, which may be composed in an acyclic graph, with single source vertex, unique universal identifiers, and having an IN degree of one (each vertex having exactly one parent). The graph may use a chain of descriptive post-coordinated terms to prescribe pre-coordinated terms contained in the 2015 Edition Common Clinical Data Set. Medical terminology codes are first class citizens of the data model, with each terminal vertex as an equivalent member of the class of pre-coordinated terms from “best available” (CPT, ICD-10). Terminal vertices may be associated with full text matching of parent chains along the full path diameter (root→terminal vertex) of the hierarchy.

Navigation performance may be optimized by strict lineage classifiers that are both obvious and precise. Due to the complexity of the medical industry domain, the taxonomy is not trivial; it contains 6-14 generations of detail, greater than 1 million post-coordinated terms, and multiple entry points in order to satisfy medical provider needs. To meet a wide range of content access needs and expectations, the system includes multiple copies of information items in different vertex chains.

In order to generate topic-specific sub-dictionaries, the terminal vertices may profile to corresponding modules, in which a recurring pattern of predicates encapsulate metadata that is relevant to the terminal vertex concept. The clinical repository 110 provides the ability to navigate fine medical encounter detail as the seed patterns create the necessary relationships between traditional terminology taxonomic systems (CPT, ICD-10-CM, and SNOMED-CT).

The concept index utilizes a novel seed pattern of attributes, extrinsic clinical characteristics which are profound, recurring and complete. Attributes provide the capability and extensibility to model disparate, abstract concepts more naturally. The repository extends existential class inheritance relationships native to CPT and ICD-10 terminologies to provide a formal framework of assertions. An RDF of triplets forms diagnosis-attribute-concept expressions. By example, an important relationship to the health informatics domain is the ‘symptomOf’ relationship, which is used to describe how particular concepts may be symptoms of some particular disease process. Other relationships describe how a disease state is ‘diagnosedBy’, or is ‘treatedWith’ another object. Wherever appropriate, matching to disease-specific metadata to CPT level II occurs natively thereby achieving Medicare Access and CHIP Reauthorization Act (“MACRA”) and Merit-Based Incentive Payment System (“MIPS”) targets.

The system 100 may comprise a user device 120 comprising a graphical user interface. The user device 120 may be a personal computer, tablet, smartphone, voice personal assistant, or any other suitable device comprising a graphical user interface.

The user device 120 may comprise a template for a template that separates functions of concept location and metadata content on the user interface template in a consistent, reliable and contextual manner. In various embodiments, representation for elements (an instance of a “class”) is represented as a box with separate slots.

Instances are populated in the graphical user interface by querying a structured repository. In various embodiments, the user device 120 interacts with the clinical repository 110 by means of a sematic navigator which runs on a light weight device which makes SQL API calls to the clinical repository 110 using API 130. Focused and contextual data visualization is provided in an efficient, space constrained, multifocal layout on the user device 120. Pre-defined edges connect clinical vertices (nodes) and enable real time forward chain inferencing with relevant portions of the knowledge graph. The system 100 may output concurrent human- and machine-readable content.

The system 100 may comprise one or more API's that complement currently available EHR systems 140. ERR systems 140 may comprise existing servers and databases which store electronic health records. Captured data is communicated back into Certified Electronic Health Record Technologies (CEHRT) systems by a server-based database 150 using FHIR Draft Standard for Technical Use 2 (DSTU2) ReST API 132. The system 100 may leverage standardized FHIR protocols in a vendor-agnostic manner. Alternatively, the system may utilize HL-7, DIRECT, or ALTERNATIVE methods to communicate information to/from other CEHRT technologies. A content delivery application (“CDA”) compiles both human-readable and machine-readable information and transports Protected Health Information to/from Health Information Technology systems in a HIPPA-compliant manner. Communication protocols with ERR vendors utilize the FHIR Draft Standard for Technical Use 2 (DSTU2) ReSTful API 132 using JSON scripting to communicate RESOURCE data. The solution utilizes a channel-based architecture via a MIRTH Connect engine which configures connections and endpoint protocol details.

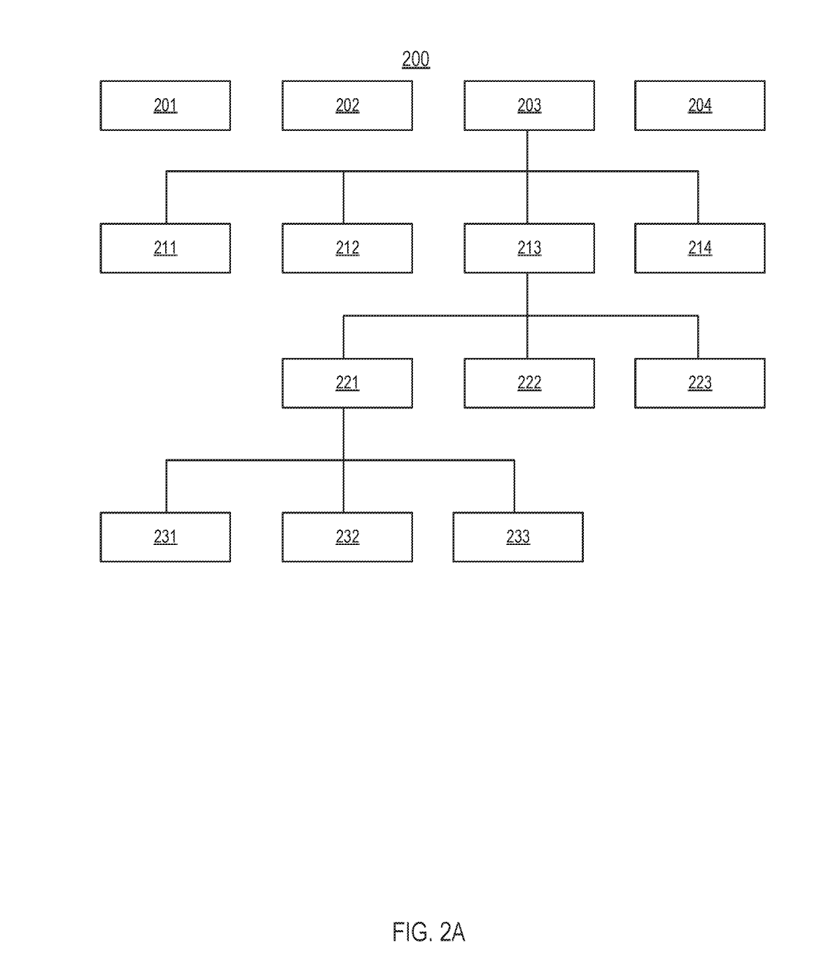

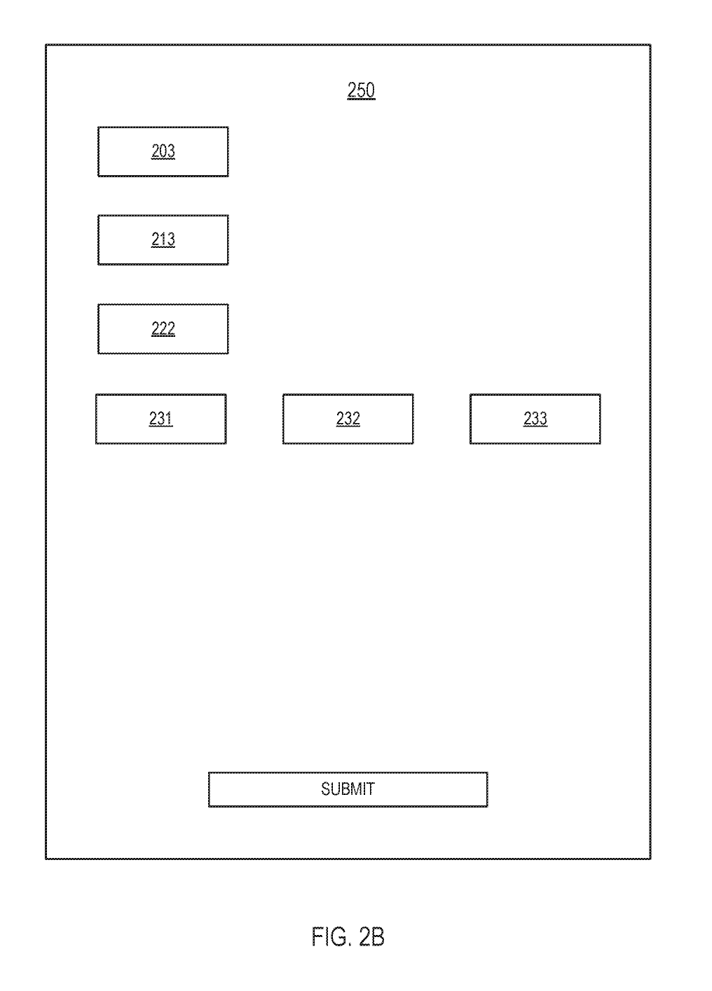

Referring to FIG. 2A, a schematic diagram of a method for navigating a linear hierarchical data set 200 is illustrated according to various embodiments. The linear hierarchical data set 200 may comprise a plurality of root data elements 201, 202, 203, 204. Each root data element 201, 202, 203, 204 may be associated with one or more second generation data elements, such as second generation data elements 211, 212, 213, 214 associated with root data element 203. Similarly, each second generation data element 211, 212, 213, 214 may be associated with one or more third generation data element, such as third generation data elements 221, 222, 223 associated with second generation data element 213. Third generation data element 221 is shown as having three associated fourth generation data elements 231, 232, 233. In response to a user selecting a data element, the associated child data elements of the lower generation may be presented to the user for further selection until no more generations are present (i.e. until a terminal vertex is reached).

Referring to FIG. 2B, an example screenshot of a GUI 250 for a provider interface corresponding to the linear hierarchical data set 200 shown in FIG. 2A is illustrated according to various embodiments. The GUI 250 may comprise a content navigation system which provides an intuitive and uncluttered user experience. The GUI 250 may allow a user, even with limited expertise, to navigate the concept index using a hypertext-based method rather than a lexical (dictation, typing) data entry method. The navigational software may be embedded on the mobile device. The GUI 250 parses complex medical scenarios into a manageable and non-distracting format optimized for use on a mobile device and a touch screen interface.

As the provider selects one data element from a generation of data elements, the selected data element may move to the left portion of the GUI 250, and the next generation of data elements may be displayed for the provider's selection. Each data element may comprise hypertext which links the data element to its associated data elements. As shown, the provider has selected the root data element 203, the second generation data element 213, and the third generation data element 222. In response to the provider selecting the third generation data element 222, the fourth generation data elements 231, 232, 233 are displayed. If there is insufficient screen area for the data elements, the provider may be able to scroll left-right or up-down as necessary to view the different data elements. The provider may select a data element by any known method, such as by tapping on a touch-screen, swiping, clicking with a pointer, speaking a command, etc.

In various embodiments, multiple generations of data elements may be simultaneously displayed on the GUI 250. As illustrated, the root data element 203, the second generation data element 213, and the third generation data element 222 are illustrated on the GUI 250 while the provider is selecting between the fourth generation data elements 231, 232, 233. By displaying multiple generations of data elements, the GUI 250 may provide context to the provider that assists the provider in understanding where in the hierarchy the provider is currently located. In various embodiments, each data element displayed on the GUI 250 may be selectable. For example, in response to the provider selecting the second generation data element 213, the GUI 250 may display the third generation data elements associated with the second generation data element 213.

In various embodiments, a provider may be able to store one or more favorite starting data elements. For example, the provider may frequently use the third generation data element 222, and the provider may store the third generation data element 222 as the default data element to start with when initiating the content navigation system. In various embodiments, the provider may store multiple data elements as favorites, and the GUI 250 may display a list of the favorite data elements in response to the provider initiating the content navigation system.

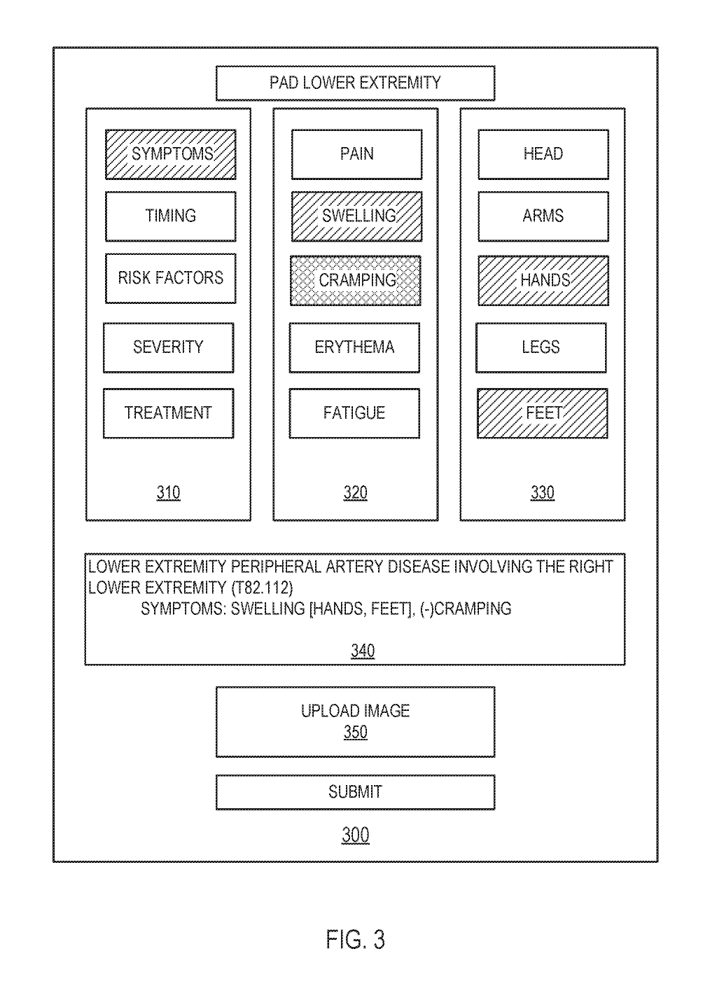

Referring to FIG. 3, an example screenshot of a graphical user interface 300 on a user device is illustrated in accordance with various embodiments. The system utilizes an object oriented methodology with declarative query commands that treat data as objects with defined attributes, methods, and relationships. The GUI 300 may be representative of a data element selected by the provider from the GUI 250 shown in FIG. 2B. For example, one of the fourth generation data elements may represent peripheral arterial disease in a right lower extremity, and the GUI 300 may provide a triplet interface for peripheral arterial diseases in a right lower extremity. The system queries asserted triplets from the specific RDF contained in the concept index. Diagnosis attributes are listed in the left-most column 310. For example, the diagnosis attributes may include symptoms, timing, risk factors, severity, treatment, etc. Due to strict adherence to a seed pattern, which is recurring across the spectrum of medical ailments, users rapidly become accustomed to available options. Concept metadata specific to the selected attribute are displayed in the center column 320. For example, concept metadata may include pain, swelling, cramping, erythema, fatigue, etc. When concept metadata are selected, the system offers the option of choosing greater specificity by displaying multigenerational concepts elements in the right column 330. For example, the elements may include head, arms, hands, legs, feet, etc.

The system enables heuristic capabilities through the provision of option selection in both the affirmative (e.g. a particular symptom IS present) and the negative (e.g. a particular symptom IS NOT present). For example a user may click on a condition once to indicate that the condition is present, click a second time to indicate that the condition is not present, and click on the condition a third time to remove any indications. The affirmative or negative conditions may be presented in different colors or patterns to illustrate whether the condition is positive or negative. For example, swelling is illustrated in a first pattern indicating that swelling is present, and cramping is illustrated in a second pattern indicating that cramping is not present. Thus, data elements may have three states: affirmative, negative, or neutral. The system may further present a textual summary 340 of the information input by the provider. Once the provider is done inputting the information, the provider may submit the record.

In various embodiments, the system may enable a user to input an image, such as a photograph or drawing. The user may select an upload image button 350, and the user may take a photograph, use a stored photograph, or create a drawing on the GUI. 300. Thus, the user may be able to quickly photograph a visible patient condition and store the photograph with the electronic health record. Metadata associated with the image may indicate that the image is associated with the particular concept being submitted. For example, the system may concatenate metadata with the image data indicating that the image is associated with swelling of the hands and feet.

The RDF concept index and navigational interface make available very large amounts of structured content for a singular clinical concept, referencing 500-1000 structured metadata concepts using a very facile point and click (hypertext) mechanism. The data model is fully attributed, providing both machine-readable code (SNOMED, LOINC, and RxNorm) and human-readable text.

The specialized navigation provides several advantages over traditional user interface technologies. By serving information that adheres to the seed pattern of attributes, the user is immediately provided with content to help discern the most suitable data. In addition, the hierarchical pattern limits data presented on the GUI 300 to small lists reducing confusion and expediting selection. In response to a provider submitting the input information, the system may transmit a record to an EHR system which may store the record in both human-readable text and machine-readable code.

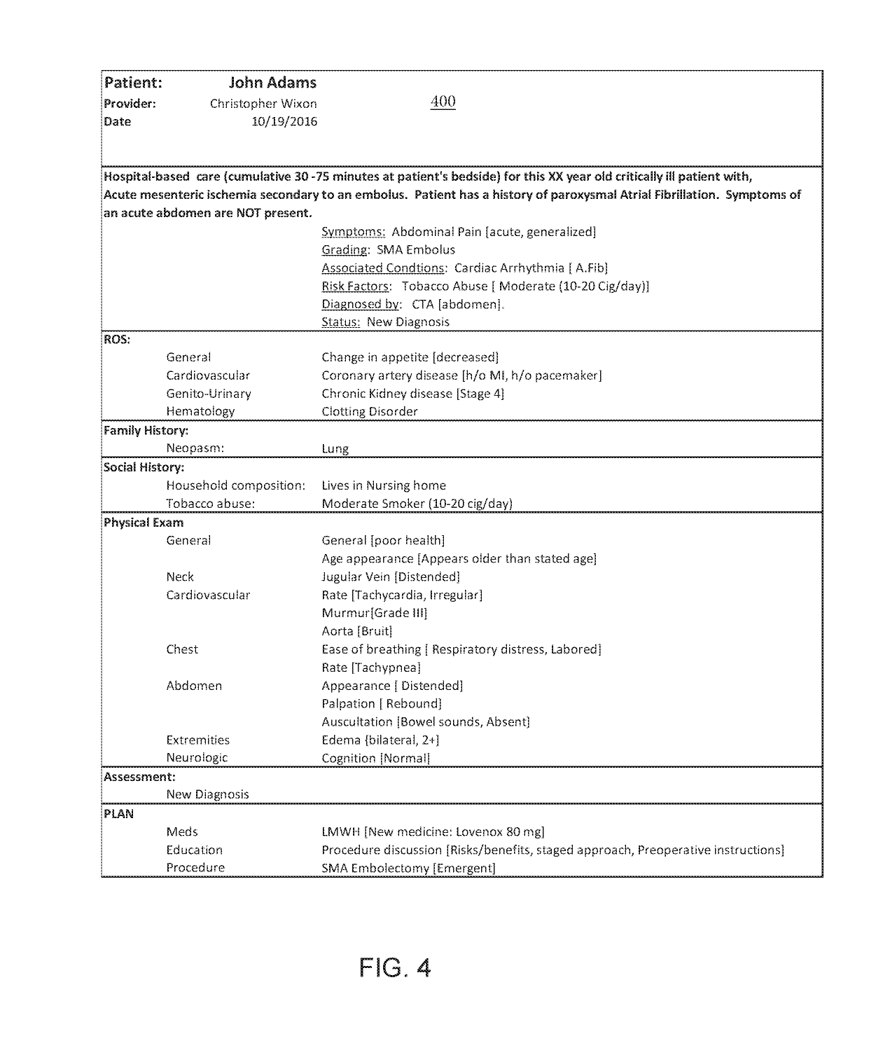

Referring to FIG. 4, an example of a record 400 which is provided in human-readable text is illustrated according to various embodiments. The record 400 may comprise a summary of a patient-provider interaction in which the provider input information into a hypermedia interface terminology system as described with reference to FIGS. 1-3. For example, the record 400 may comprise patient information, visit information, review of symptoms (“ROS”), family history, social history, physical exam results, assessment, plan, etc. In various embodiments, the application provides full text matching for the post-coordinated terms that the user selected.

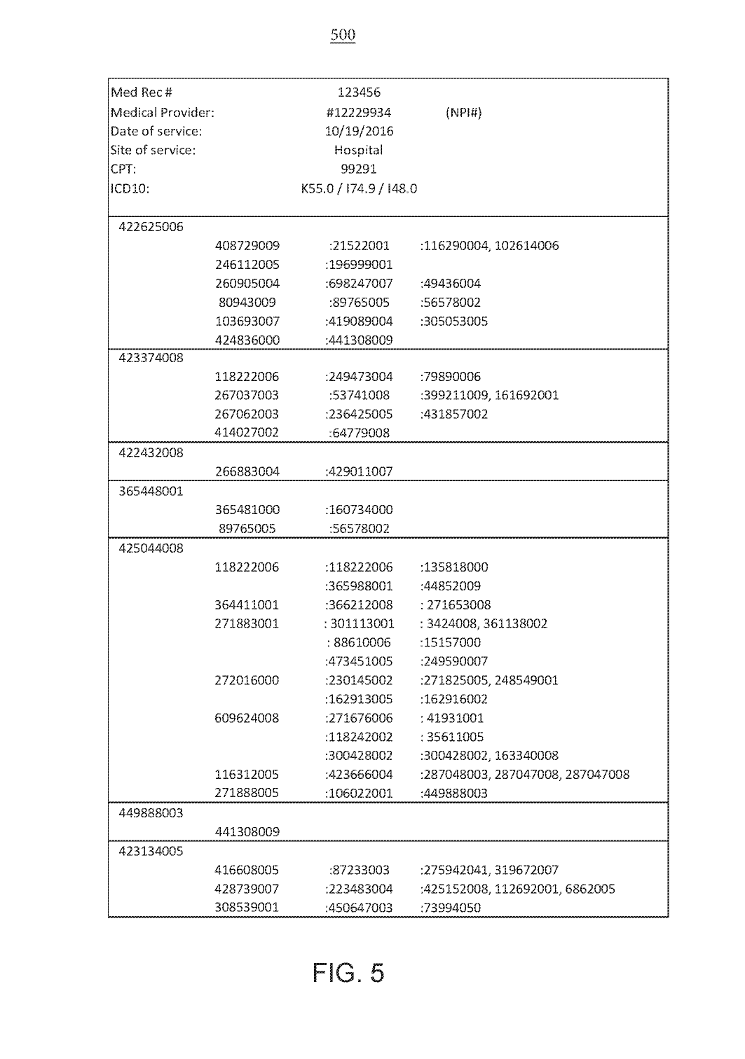

Referring to FIG. 5, an example of a screenshot of a record 500 which is provided in machine-readable code is illustrated according to various embodiments. The record 500 may represent the same information as the record 400 shown in FIG. 4, such as patient information, visit information, ROS, family history, social history, physical exam results, assessment, plan, etc. However, the record 500 may represent the same information in numeric or alphanumeric strings of characters which represent the same concepts input by the provider.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as a processor for generating medical informatics documentation. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, components, modules, and/or engines of system may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); JAVA® 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

As used herein, “transmit” may include sending electronic data from one system component to another over a network connection. Additionally, as used herein, “data” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The disclosure and claims do not describe only a particular outcome of creating and storing electronic health records, but the disclosure and claims include specific rules for implementing the outcome of creating and storing electronic health records and that render information into a specific format that is then used and applied to create the desired results of creating and storing electronic health records, as set forth in McRO, Inc. v. Bandai Namco Games America Inc. (Fed. Cir. case number 15-1080, Sep. 13, 2016). In other words, the outcome of creating and storing electronic health records can be performed by many different types of rules and combinations of rules, and this disclosure includes various embodiments with specific rules. While the absence of complete preemption may not guarantee that a claim is eligible, the disclosure does not sufficiently preempt the field of creating and storing electronic health records at all. The disclosure acts to narrow, confine, and otherwise tie down the disclosure so as not to cover the general abstract idea of just creating and storing electronic health records. Significantly, other systems and methods exist for creating and storing electronic health records, so it would be inappropriate to assert that the claims preempt the field or monopolizes the basic tools of creating and storing electronic health records. In other words, the disclosure will not prevent others from creating and storing electronic health records, because other systems are already performing the functionality in different ways than the claims. Moreover, the claims include an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include a graphical user interface for dynamically relocating/resealing obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

Benefits, other advantages, and solutions to problems have been described herein with regard to specific embodiments. Furthermore, the connecting lines shown in the various figures contained herein are intended to represent various functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of exemplary embodiments. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
providing, by a computer-based system, a graphical user interface comprising a plurality of root elements;
receiving, by the computer-based system, a selection of a first root element in the plurality of root elements;
providing, by the computer-based system and in response to the selection of the first root element, a plurality of subsequent generation elements;
receiving, by the computer-based system, a selection of a first subsequent generation element in the plurality of subsequent generation elements;
determining, by the computer-based system, that the first subsequent generation element is a terminal vertex;
providing, by the computer-based system and based on the selection of the first subsequent generation element, a triplet interface corresponding to the first subsequent generation element;
receiving, by the computer-based system, a selection of a triplet from the triplet interface;
generating, by the computer-based system, a human-readable record comprising the triplet;
generating, by the computer-based system, a machine-readable record comprising the triplet; and
transmitting, by the computer-based system, the human-readable record and the machine-readable record to an electronic health record database.

2. The method of claim 1, further comprising transmitting, by the computer-based system, an API call to a clinical repository in response to the selection of the first root element.

3. The method of claim 2, wherein the clinical repository comprises a human-edited repository of clinical concepts arranged in a multi-graph format.

4. The method of claim 1, wherein the triplet comprises a diagnosis-attribute-concept expression.

5. The method of claim 1, wherein the triplet comprises an affirmative state, a negative state, and a neutral state.

6. The method of claim 1, further comprising:
providing, by the computer-based system and in response to the selection of the triplet from the triplet interface, a plurality of subsequent triplet generation elements; and
receiving, by the computer-based system, a selection of subsequent triplet generation elements in the plurality of subsequent triplet generation elements.

7. The method of claim 1, further comprising selecting, by the computer-based system, the plurality of subsequent generation elements using forward chain inferencing.

8. An article of manufacture including a non-transitory, tangible computer-readable storage medium having instructions stored thereon that, in response to execution by a computer-based system, cause the computer-based system to perform operations comprising:
providing, by the computer-based system, a graphical user interface comprising a plurality of root elements;
receiving, by the computer-based system, a selection of a first root element in the plurality of root elements;
providing, by the computer-based system and in response to the selection of the first root element, a plurality of subsequent generation elements;
receiving, by the computer-based system, a selection of a first subsequent generation element in the plurality of subsequent generation elements;
determining, by the computer-based system, that the first subsequent generation element is a terminal vertex;
providing, by the computer-based system and based on the selection of the first subsequent generation element, a triplet interface corresponding to the first subsequent generation element;
receiving, by the computer-based system, a selection of a triplet from the triplet interface;
generating, by the computer-based system, a human-readable record comprising the triplet;
generating, by the computer-based system, a machine-readable record comprising the triplet; and
transmitting, by the computer-based system, the human-readable record and the machine readable-record to an electronic health record database.

9. The article of manufacture of claim 8, further comprising transmitting, by the computer-based system, an API call to a clinical repository in response to the selection of the first root element.

10. The article of manufacture of claim 9, wherein the clinical repository comprises a human-edited repository of clinical concepts arranged in a multi-graph format.

11. The article of manufacture of claim 8, wherein the triplet comprises a diagnosis-attribute-concept expression.

12. The article of manufacture of claim 8, wherein the triplet comprises an affirmative state, a negative state, and a neutral state.

13. The article of manufacture of claim 8, wherein the first root element comprises hypertext.

14. The article of manufacture of claim 8, further comprising selecting, by the computer-based system, the plurality of subsequent generation elements using forward chain inferencing.

15. A system comprising:
a processor,
a tangible, non-transitory memory configured to communicate with the processor,
the tangible, non-transitory memory having instructions stored thereon that, in response to execution by the processor, cause the processor to perform operations comprising:
providing, by the processor, a graphical user interface comprising a plurality of root elements:
receiving, by the processor, a selection of a first root element in the plurality of root elements;
providing, by the processor and in response to the selection of the first root element, a plurality of subsequent generation elements;
receiving, by the processor, a selection of a first subsequent generation element in the plurality of subsequent generation elements;
determining, by the processor, that the first subsequent generation element is a terminal vertex;
providing, by the processor and based on the selection of the first subsequent generation element, a triplet interface corresponding to the first subsequent generation element;
receiving, by the processor, a selection of a triplet from the triplet interface;
generating, by the processor, a human-readable record comprising the triplet;
generating, by the processor, a machine-readable record comprising the triplet; and
transmitting, by the processor, the human-readable record and the machine-readable record to an electronic health record database.

16. The system of claim 15, further comprising transmitting, by the processor, an API call to a clinical repository in response to the selection of the first root element.

17. The system of claim 16, wherein the clinical repository comprises a human-edited repository of clinical concepts arranged in a multi-graph format.

18. The system of claim 15, wherein the triplet comprises a diagnosis-attribute-concept expression.

19. The system of claim 15, wherein the triplet comprises an affirmative state, a negative state, and a neutral state.

20. The system of claim 15, wherein the first root element comprises hypertext.
